(19) United States
(12) Patent Application Publication
(10) Pub. No.: US 2013/0207415 A1
(43) Pub. Date: Aug. 15, 2013

(54) ROOF ASSEMBLY FOR A TRAILER

(71) Applicant: Andrzej Wylezinski, Lafayette, IN (US)

(72) Inventor: Andrzej Wylezinski, Lafayette, IN (US)

(21) Appl. No.: 13/764,843

(22) Filed: Feb. 12, 2013

Related U.S. Application Data
(60) Provisional application No. 61/598,033, filed on Feb. 13, 2012.

(51) Int. Cl. B62D 25/06

(52) U.S. Cl. CPC B62D 25/06
USPC 296/185.1; 296/210

(57) ABSTRACT

A roof assembly of a trailer includes a plurality of roof panels. Each roof panel includes a main body, a first flange extending downwardly from a first lateral edge of the main body, and a second flange extending downwardly from a second lateral edge of the main body. Illustratively, flange and the main body are made from a single, or one-piece, sheet of material.

This application claims priority under 35 U.S.C. §119(e) to U.S. Provisional Patent Application Ser. No. 61/598,033 entitled ROOF ASSEMBLY FOR A TRAILER and filed Feb. 13, 2012, the entirety of which is hereby incorporated by reference herein.

### FIELD OF THE INVENTION

The present invention relates generally to storage containers such as mobile storage containers for trailers. Particularly, the present invention relates to roof and sidewall structures for such storage containers.

### BACKGROUND OF THE INVENTION

Conventional roofs for storage containers, and particularly for mobile storage containers, may be provided in various forms. For example, in conventional box or van-type trailers, a roof assembly may include a number of roof bows extending between and along the trailer sidewalls and a flexible sheet or cover supported by the roof bows. The flexible cover is typically coupled to a top rail of each sidewall of the trailer. For example, a typical sidewall may include a top rail to run along a length of the trailer and a plurality of sidewall panels each having a top portion coupled to the top rail. The top rails are also coupled to each of the respective right and left lateral sides of the roof assembly. For example, each top rail is coupled both to one side of the roof assembly and to the corresponding one of the sidewall panels of the trailer. Oftentimes, the flexible cover may be pre-stressed by crimping the skin around a portion of the top rails in order to add strength to the roof assembly. The top rails and the roof bows may intrude into the inside cargo area of the storage container and, therefore, may reduce the usable height and/or width of the storage container, thus reducing the amount of cargo which may be carried within the storage container. Further, intruding portions of the top rails and roof bows may be damaged from fork truck masts and cargo as the cargo is loaded and unloaded into and out of the storage container. It is desirable to improve storage container roofing and sidewall technology generally, and particularly roofing technology for transportable storage containers.

### SUMMARY

The present invention may comprise one or more of the features recited in the attached claims, and/or one or more of the following features and combinations thereof.

According to one aspect of the present disclosure, a roof assembly of a storage container having two opposing sidewalls, including one or more sidewall panels, that together define a length of the trailer, includes a plurality of roof panels arranged atop and between the two opposing sidewalls along the length of the storage container in side-by-side relationship. Each roof panel includes (i) a main body, (ii) a first flange extending downwardly from a first lateral edge of the main body to define a first approximately 90° bend, and (iii) a second flange extending downwardly from a second lateral edge of the main body to define a second approximately 90° bend. The first flange is configured to be coupled to and engaged with one of the sidewall panels of the trailer and second flange is configured to be coupled to and engaged with one other of the sidewall panels of the trailer.

In one illustrative embodiment, the first flange, the second flange, and the main body may define a one-piece structure.

In another illustrative embodiment, each roof panel may include opposite sides and opposite ends. Further, adjacent roof panels may be coupled to each other in such a way as to form a shiplap joint between opposite sides of the adjacent roof panels.

In still another illustrative embodiment, the roof assembly may also include an adhesive between opposite sides of adjacent roof panels in order to couple adjacent roof panels to each other.

In yet another illustrative embodiment, the roof assembly may also include adhesive on an inside surface of each flange of each one of the plurality of roof panels such that each flange is configured to be coupled directly to a top portion of one of the sidewall panels of the trailer.

In still another illustrative embodiment, each roof panel may be made from a composite material. Illustratively, the composite material may include an outer metal skin, an inner metal skin, and a foam core between the inner and outer metal skins.

In yet another illustrative embodiment, each of the plurality of roof panels may be formed by roll-forming top and bottom end portions of a planar sheet of material to form a one-piece structure.

In still another illustrative embodiment, the main body of each roof panel may be generally planar.

In yet another illustrative embodiment, the main body of each roof panel may be bowed between first and second lateral edges thereof such that the roof assembly may be substantially dome-shaped along a longitudinal axis defined by the trailer centrally between the two opposing side walls of the trailer.

In still another illustrative embodiment, the roof assembly may be void of support structure extending laterally between the sidewalls of the trailer and coupled to the main body, the first flange, and the second flange of the roof panel.

According to another aspect of the present disclosure, a roof assembly of a trailer includes a one-piece roof panel including (i) a main body configured to extend a width of the trailer between a first and a second sidewall of the trailer, (ii) a first bend at a first lateral edge of the main body, (iii) a first flange extending downwardly from the first bend, (iv) a second bend at a second lateral edge of the main body, and (v) a second flange extending downwardly from the second bend.

In one illustrative embodiment, the one-piece roof panel may include an outer skin, an inner skin, and a foam core between the inner and outer skins. Further, the roof assembly may also include a plurality of one-piece roof panels such that abutting first and second lateral edges of adjacent ones of the plurality of roof panels are configured to be attached together by overlapping the outer skin along the adjacent side of one of the adjacent roof panels onto the other adjacent roof panel and overlapping the inner skin along the adjacent side of the other adjacent roof panel onto the one of the adjacent roof panels. Illustratively, the inner and outer skins of each roof panel may be metal.

In another illustrative embodiment, the roof assembly may also include an adhesive coupled to (i) an inner surface of the first flange and (ii) an inner surface of the second flange. Illustratively, the inner surface of the first flange may be configured to be coupled to and engaged with an outer surface of a sidewall panel of the first sidewall of the trailer. Similarly, the inner surface of the second flange may be configured to be coupled to and engaged with an outer surface of a sidewall panel of the second sidewall of the trailer.

According to still another aspect of the present disclosure, a trailer includes a floor assembly, a first sidewall coupled to a first side of the floor assembly and extending upwardly therefrom, and a second sidewall coupled to a second side of the floor assembly and extending upwardly therefrom. Illustratively, the first sidewall includes a first plurality of sidewall panels coupled to each other and extending the length of the trailer. Further, the second sidewall includes a second plurality of sidewall panels coupled to each other and extending the length of the trailer. The trailer further includes a roof assembly coupled directly to the first plurality of sidewall panels and coupled directly to the second plurality of sidewall panels. Illustratively, the roof assembly includes a plurality of roof panels arranged atop and between the first and second sidewalls along the length of the trailer in side-by-side relationship. Each roof panel includes (i) a main body, (ii) a first flange extending downwardly from a first lateral edge of the main body, and (iii) a second flange extending downwardly from a second lateral edge of the main body. The first flange is coupled to an outer surface of the first sidewall and the second flange is coupled to an outer surface of the second sidewall. Further, each roof panel defines a one-piece structure made from a composite material including an outer skin, an inner skin, and a foam core between the inner and outer skins.

In one illustrative embodiment, each sidewall panel of the first and second plurality of sidewall panels may be made from a composite material and may include an outer skin, an inner skin, and a foam core between the inner and outer skins. Further illustratively, the inner skin of the first flange of each roof panel may be engaged with and adhesively coupled to the outer skin of the first plurality of sidewall panels. Similarly, the inner skin of the second flange of each roof panel may be engaged with and adhesively coupled to the outer skin of the second plurality of sidewall panels.

In another illustrative embodiment, no portion of the roof assembly extends inwardly into the trailer beyond an inner surface of each of the first and second plurality of sidewall panels.

In still another illustrative embodiment, the first flange may generally be parallel to the first plurality of sidewall panels and the second flange may generally be parallel to the second plurality of sidewall panels.

### BRIEF DESCRIPTION OF THE DRAWINGS

FIG. 1 is a rear perspective view of a portion of a trailer including a roof assembly of the present disclosure.

FIG. 2 is a perspective view of one of the roof panels of the roof assembly of FIG. 1.

FIG. 3 is a perspective view of an alternative roof panel of the present disclosure.

FIG. 4 is a sectional view taken along line 4-4 of FIG. 1 showing the connection between the roof assembly and one of the sidewall panels of the trailer of FIG. 1.

FIG. 5 is a sectional view taken along line 5-5 of FIG. 1 showing a shiplap joint of two adjacent roof panels.

FIG. 6 is a perspective view of a one-piece sheet of composite material from which the roof panels of FIGS. 1-5 are made.

### DETAILED DESCRIPTION OF THE PREFERRED EMBODIMENT

For the purposes of promoting an understanding of the principles of the invention, reference will now be made to illustrative embodiments shown in the attached drawings and specific language will be used to describe the same. While the concepts of this disclosure are described in relation to a truck trailer, it will be understood that they are equally applicable to other vehicles having a roof and sidewall assembly, to other mobile or stationary storage containers, as well as to refrigerated and un-refrigerated trailers or truck bodies. Accordingly, those skilled in the art will appreciate that the present invention may be implemented in a number of different applications and embodiments and is not specifically limited in its application to the particular embodiments depicted herein.

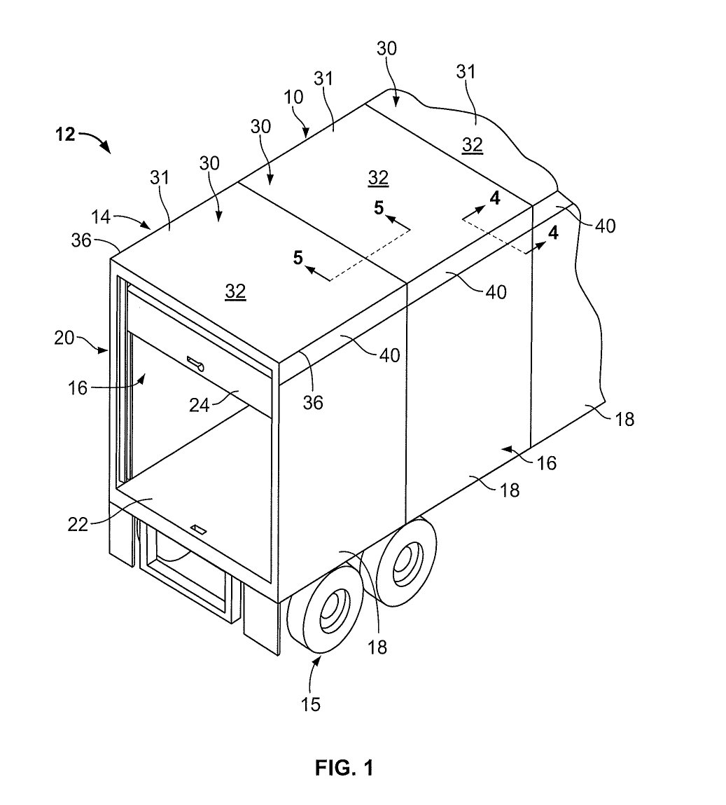

Referring now to FIG. 1, one illustrative embodiment of a roof assembly 10 for a trailer 12 is provided. Illustratively, the trailer 12 is a conventional box or van-type trailer that is towable by a heavy duty truck (not shown), although it will be understood that the roof assembly 10 may be mounted to other trailer types and/or to other storage containers generally. As shown in FIG. 1, the trailer 12 includes a storage container 14, a wheel base 15 coupled to the storage container 14, and a kingpin and landing gear (not shown) also coupled to the storage container 14. In the illustrative embodiment, the storage container 14 includes a pair of opposing sidewalls 16 that extend the length of the trailer 12. Illustratively, the sidewalls 16 each include a plurality of vertically-extending sidewall panels 18 coupled to each other and which extend along a length of the trailer 12. The sidewalls 16 may include any number of sidewall panels 18 or may include a single sidewall panel which extends the entire length of the trailer 12. Illustratively, the trailer 12 further includes a front wall (not shown) attached to and between the sidewalls 16 at a front end of the trailer 12, and a rear frame 20 attached to and between the sidewalls 16 at a rear end of the trailer 12. A floor assembly 22 of the storage container 14 is coupled to the front wall, the rear frame 20, and the sidewalls 16. A conventional door assembly 24 is mounted to the rear frame 20. As is discussed in greater detail below, the trailer 12 does not include a top rail (not shown) typically provided to couple the sidewall panels of a trailer to the roof assembly of the trailer.

The roof assembly 10 is coupled to the sidewalls 16, the rear frame 20, and the front wall of the trailer 12. The roof assembly 10 includes a plurality of individual and separate roof panels 30 arranged in side-by-side relationship atop the trailer 12 and extending along the length of the trailer 12. Illustratively, the roof assembly 10 may include any number of roof panels 30 as well as a single roof panel (not shown) which is configured to extend generally the entire length of the storage container 14. The roof panels 30 are configured to be joined together and secured generally to the tops of the sidewalls 16. In particular, the roof panels 30 are configured to be coupled directly to the sidewall panels 18 of the trailer 12. As is discussed in greater detail below, the roof panels 30 are joined to each other using a shiplap joint 50.

Illustratively, the free side, or the rear edge 38, of the rear-most roof panel 30 is attached to the top of the rear frame 20 and the free side, or the front edge 38, of the forward-most roof panel 30 is attached to the top of the front wall of the storage container 14. Illustratively, the free sides of the rear-most and forward-most roof panels 30 are attached to the tops of the rear frame 20 and front wall respectively via a number of conventional fasteners such as rivets, threaded nut/bolt combinations or the like. Alternatively, or additionally, the free sides of the roof panels 30 may be attached to the tops of the rear frame 20 and front wall respectively via a conventional bonding medium and/or via welds as well.

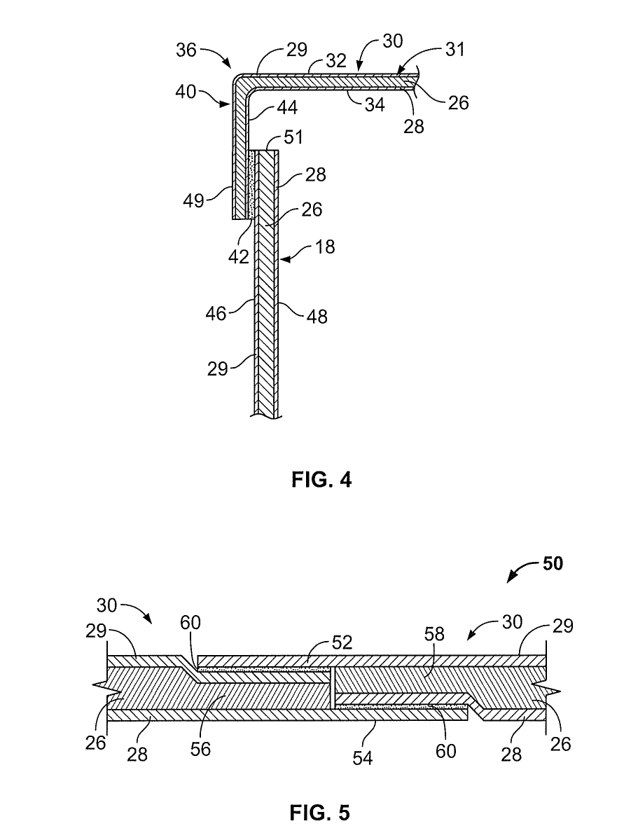

As is discussed in greater detail below, the opposite ends of each roof panel 30 define flanges 40 which are attached to and along corresponding sidewall panels 18. In particular, each of the roof panels 30 is attached at one end thereof along the top of one of the sidewall panels 18 of the sidewalls 16 and at an opposite end along the top one of the sidewall panels 18 of the other sidewall 16. In the illustrated embodiment, and as discussed in greater detail below, the top of each sidewall panel 18 is attached directly to the roof assembly 10, thus eliminating the need for top rails typically used to connect the top of a sidewall panel to a roof assembly. Thus, the sidewalls 16 of the trailer 12 are rail-less in that the sidewalls 16 do not include any top rail coupled to a top portion of the sidewall panels 18 to extend along the length of the trailer 12. As shown in FIG. 1 and FIG. 4, therefore, the sidewall panels 18 do not extend the full height of the storage container 14. Rather, one of the flanges 40 from each roof panel 30 extends perpendicularly to a top surface of the roof assembly 10 to couple directly to the sidewall panels 18 to define a portion of the height of the storage container 14. As is further discussed in greater detail below, the flanges 40 of the roof assembly 10 attach directly to the sidewall panels 18 of the trailer 12.

As shown in FIGS. 1, 2, and 4, each roof panel 30 includes a main body 31 defining a top, or outer, surface 32 and a bottom, or inner, surface 34. Further illustratively, the main body 31 of each panel 30 includes first and second lateral edges 36 as well as front and rear edges 38. The main body 31 defines the top horizontal surface of the storage container 14. As is discussed in greater detail below, the front and rear edges 38 of adjacent panels 30 are coupled to each other and cooperate with each other in order to define an upper, generally continuous surface, of the roof assembly 10. Also, as is discussed in greater detail below, the illustrative joint 50 (shown in FIG. 5) between adjacent roof panels 30 is a shiplap joint. Illustratively, each roof panel 30 further includes the end flanges 40 coupled to each of the first and second lateral edges 36 of the main body 31. Each flange 40 extends downwardly from the main body 31 at approximately a 90 degree angle to the main body 31 to couple directly with one or more of the sidewall panels 18 of the sidewall 16.

Illustratively, the panels 30 are formed from a unitary sheet 70 of material which is bent, or roll-formed, at top and bottom ends thereof to create the main body 31 and the lateral flanges 40 extending downwardly therefrom. As such, the first and second lateral edges 36 of each roof panel 30 define bends formed in the initial sheet of material. Specifically, each roof panel 30 includes a 90 degree bend 36 at each of the lateral edges of the main body 31. Thus, each roof panel 30 forms a one-piece component made from a one-piece, or monolithic, sheet 70 of material which is bent, or roll-formed. In other words, the main body 31 and two end flanges 40 of each panel 30 define a monolithic sheet of material that consists of or constitutes a single unit.

Illustratively, as noted above, the flanges 40 of each panel 30 are coupled to the sidewalls 16 of the trailer 12. As shown in FIG. 1, the sidewall 16 includes the plurality of panels 18 such that each flange 40 is coupled to a top portion of one of the sidewall panels 18. Illustratively, the roof panels 30 and the sidewall panels 18 are generally aligned with each other such that a single roof panel 30 is coupled at one end to a single sidewall panel 18 and at the other end to another single sidewall panel. It should be understood, however, as noted above that each sidewall 16 may include any number of panels such that the flange 40 of each roof panel 30 may be coupled to one or more sidewall panels 18. Further, flanges 40 of adjacent roof panels 30 may be coupled to at least a portion of the same sidewall panel 18.

As shown in FIG. 4, the sidewall panel 18 and the flange 40 of each roof panel 30 are coupled to each other by a bonding medium 42. Illustratively, the bonding medium 42 may comprise a conventional adhesive. For example, the bonding medium 42 may be provided in the form of a two-part epoxy or acrylic adhesive that cures to a hardened state after mixing the two parts together in a conventional manner. Alternatively, the bonding medium 42 may be or include a conventional sealing medium or other conventional bonding medium. In an alternative embodiment, the bonding medium 42 may be provided in the form of strips of a double-sided adhesive tape. Illustratively, while the adhesive 42 is used to couple the flange 40 and the sidewall panel 18 together, other suitable fasteners may be used as well. For example, the flange 40 and sidewall panel 18 may be coupled to each other using rivets, screws, nails, nuts/bolts, welds, for example.

As shown in FIG. 4, a top edge 51 of the sidewall panel 18 is spaced-apart from the inside surface 34 of the main body 31 of the roof panel 30. It should be understood, however, that the sidewall panel 18 may be taller in order to extend up to and/or be engaged with the inside surface 34 of the main body 31 such that substantially the entire inner surface 44 of the flange 40 is engaged with and coupled to the outer surface 46 of the sidewall panel 18. Illustratively, the top portion of the sidewall panel 18 is parallel to the flange 40 to which it is coupled. In other words, the flange 40 defines a generally vertical plane and the sidewall panel 18 defines a generally vertical plane that is parallel to the vertical plane defined by the flange 40.

Illustratively, as shown in FIG. 4, the flanges 40 of each panel 30 overlap the upper portion of the sidewall panels 18. This overlapping of the roof panels 30 and the sidewall panels 18 operates to double the thickness of the material at the connection. This overlapping joint between the roof panel 30s and the sidewall panels 18 operates to provide stiffness and stability for the storage container 14. Illustratively, an inside surface 44 of the flange 40 is coupled to an outside surface 46 of the sidewall panel 18. It should be understood however, that an inside surface 48 of the sidewall panel 18 may be coupled to an outside surface 49 of the flange 40 as well.

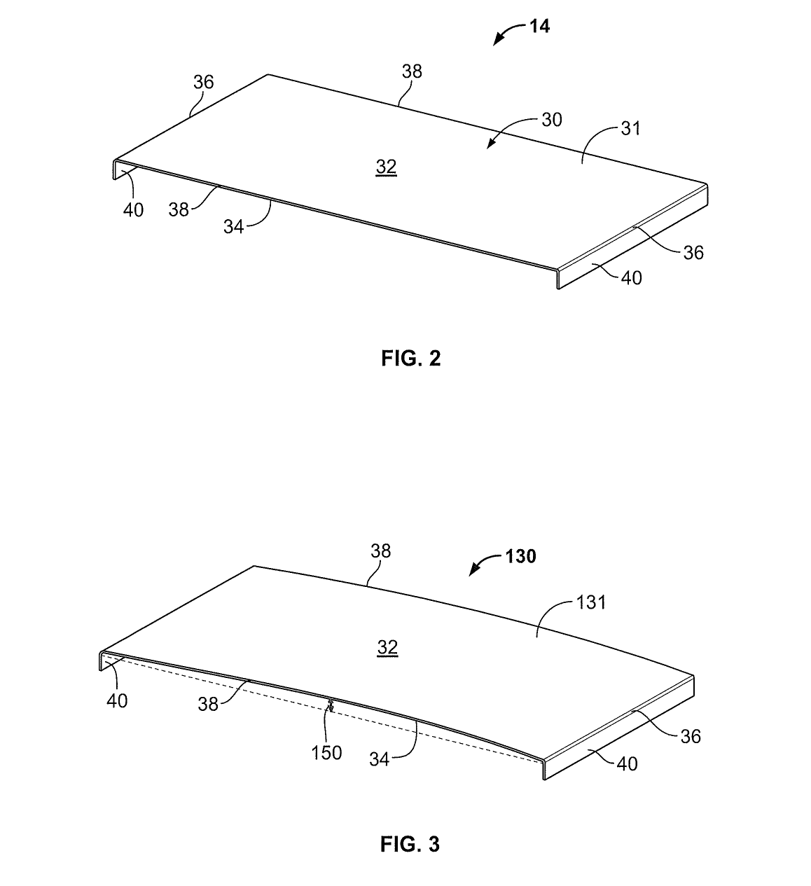

As shown in FIGS. 2 and 3, the main body 31 is generally planar to define the flat or planar roof assembly 10. Accordingly, the main body 31 defines a planar outer surface 32 and a planar inner surface 34. Alternatively, however, the main body may be curved in order to define a curved, non-planar roof assembly (not shown) including alternative roof panels 130 which each include a curved main body 131, as shown in FIG. 3. The roof panel 130 includes many of the same features of the roof panel 30 discussed above. Accordingly, the same reference numerals are used to designate same or similar components. The roof panel 130 includes the alternative main body 131 and a flange 40 coupled to each of the lateral edges, or bends, 36 of the main body 131.

As shown in FIG. 3, the main body 131 is curved, or bowed such that at least a portion of the main body 131 between the lateral edges, or bends, 36 of each roof panel 130 is configured to extend above each of the lateral bends 36. Accordingly, the roof panel 130 is generally dome-shaped along a longitudinal axis defined by the storage container 14 of the trailer 12 centrally between the two opposing sidewalls 16 of the trailer 12. Such bowing in the transverse plane may operate to assist with the shedding of water and snow from the roof assembly 10. In the embodiment illustrated in FIG. 3, for example, the roof panel 130 is non-flat such that a height of each roof panel 130 relative to the trailer 12 increases toward its center for a maximum center height 150 of the roof panel 130. Illustratively, each of the roof panels 130 of a bowed roof assembly may increase in height, relative to the trailer 12, either linearly or non-linearly toward its center. Alternatively, the roof panels 130 may increase in height, relative to the trailer 12 toward some other line or contour defined between the two opposite lateral edges, or bends, 36 thereof. In the embodiment illustrated in FIG. 3, for example, the illustrative roof panel 130 is bowed such that a roof assembly made from adjacent roof panels 130 coupled to each other would be generally dome-shaped between the trailer sidewalls 16. It will be understood, however, that FIG. 3 is provided only by way of example, and that the roof panels 130 may be alternatively shaped or contoured such that a roof assembly having other profiles is formed.

As shown in FIGS. 4-6, the illustrative sidewall panels 18 and the roof panels 30, 130 disclosed herein are each made from a composite material. The illustrative composite material of the panels 18, 30, 130 includes a plastic core 26 and inner and outer metal skins 28, 29 coupled to the plastic core 26, as shown in FIG. 4. Such a composite material provides a rigid, but lightweight and durable material. Illustratively, for example, the panels 18, 30, 130 may be made of a DURAPLATE® composite panel provided by Wabash National Corporation of Lafayette, Ind. DURAPLATE® composite panels are constructed of a high-density polyethylene plastic core bonded between two high-strength steel skins. The inner and outer skins 32, 34 respectively may be formed of a metal or metallic composition, examples of which include, but should not be limited to aluminum, galvanized steel, full hardened steel, such as AISI Grade E steel, or the like. In one illustrative embodiment, for example, the outer skin 32 is formed of ASTM G90 galvanized steel, and the inner skin 34 is formed o ASTM G40 galvanized steel. In alternative embodiments, the inner and/or outer skins 32, 34 respective may be formed of other rigid, semi-rigid, metallic or non-metallic materials. Illustratively, the composite material of the panels 18, 30, 130 is approximately between 0.08 inch and 0.20 inch thick, with a preferred thickness of approximately 0.10 inch thick. It should also be understood that the composite material used for the sidewall panels 18 may have the same or different dimensions than that used for the roof panels 30, 130. Further, while the illustrative panels 18, 30, 130 disclosed herein are each made of the particular composite material described above, it should be understood that other suitable composite materials may be used as well. For example, the panels 18, 30, 130 may also be made from a plastic pultrusion with fiber reinforcements embedded inside the polymer material. The reinforcement fibers may be made from glass, carbon, and/or other suitable materials, for example.

It should be further understood that while the illustrative panels 18, 30, 130 disclosed herein are made from a composite, the panels 18, 30, 130 may alternatively be formed from a non composite material such as a sheet made from a metal, metal alloy, or plastic, for example. The panels 18, 30, 130 may be made from ferrous or nonferrous materials including plastics or composites incorporating a combination of ferrous and/or nonferrous materials thereof. In particular, an alternative panel (not shown) may be made from galvanized steel. Of course, it is within the scope of this disclosure to include non-galvanized steel sheets, or other such non-composite panels, of any suitable thickness as well. Further, while the panels 18, 30, 130 are generally smooth, it should be understood that the roof panels 30, 130 may be configured to have corrugations formed therein as well.

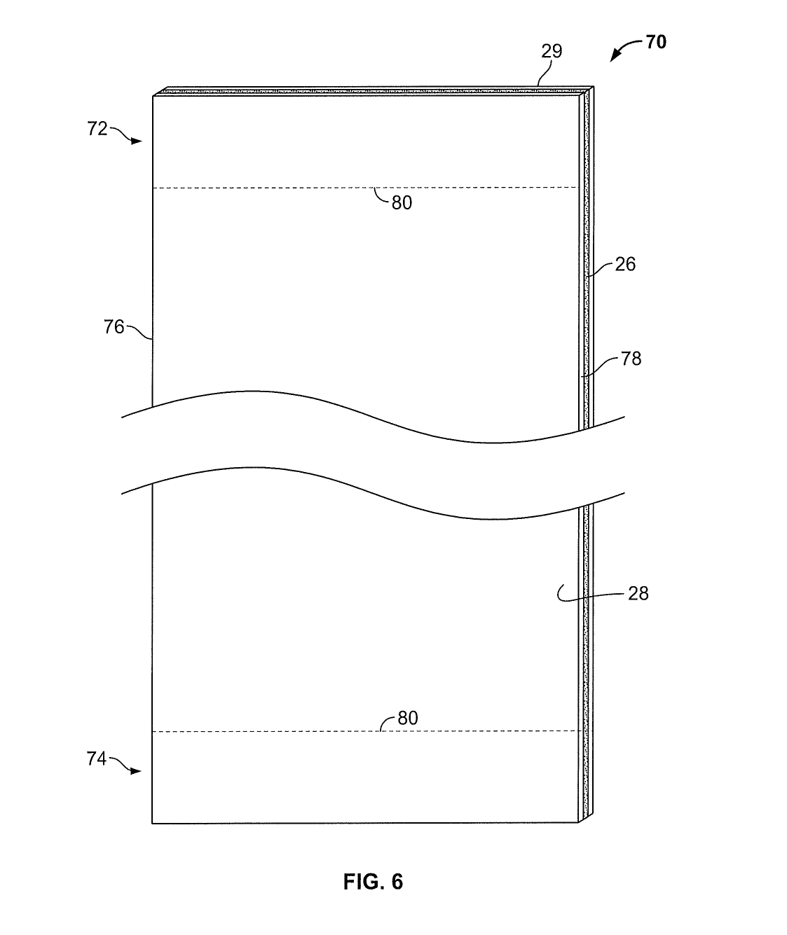

As noted above, the roof panels 30 are each made from a monolithic, or one-piece, sheet 70 of composite material, as shown in FIG. 6. Illustratively, the sheet 70 of composite material includes the foam core 26 as well as the inner and outer metal skins 28, 29 coupled to the foam core 26. Each sheet 70 of composite material includes top and bottom end portions 72, 74 as well as side edges 76, 78. Illustratively, the side edges 76, 78 form one half of a ship lap joint 50; however, for ease of illustration the side edges 76, 78 are shown without the one half of the ship lap joint 50 formed therein. Illustratively, as noted above, the sheet 70 is roll-formed to create the roof panel 30. In particular and during the roll-forming process, the end portions 72, 74 are bent generally along the dotted lines 80 shown in FIG. 6 in order to create the flanges 40 of each roof panel 30. The end portions 72, 74 are bent approximately 90° such that the flanges 40 extend generally perpendicularly to the main body 31 of the finished roof panel 30. Accordingly, the portion of the sheet 70 located between the dotted lines 80 becomes the main body 31 of the roof panel 30 and generally parallel to the sidewall panels 18 of the storage container 14. As such, the side edges 76, 78 of the composite material 70 become the front and rear edges 38 of the main body 31 of the each roof panel 30.

Referring now to FIG. 5, a cross-sectional view is shown of the roof assembly 10 of FIG. 1 as viewed along section lines 5-5 to illustrate one illustrative embodiment of the joint 50 between two adjacent panels 30 of the roof assembly 10. It will be understood that the remaining panels 30 of the roof assembly 10 are illustratively constructed in the same manner as will be describe with respect to FIG. 5. Moreover, the joint 50 illustrated in FIG. 5 may also be used to join any or all adjacent roof panels 30 of the roof assembly 10 to each other. In any case, the general form of the joint 50 between the adjacent panel sides is known in the industry as a “shiplap” joint. In the illustrated embodiment, each of the roof panels 30 includes the core member 26 that is sandwiched between the outer skin 32 and the inner skin 34. The external surface 32 of the outer skin 29 defines the outer surface of the roof assembly 10, and the external surface 34 (i.e., the inner surface of the panel 30) of the inner skin 28 defines the inner surface of the roof assembly 10. The core member 26 of each of the roof panels 30 is illustratively formed of a non-metal material, although this disclosure contemplates embodiments in which the core member may include at least some amount of a metallic material or materials. In one illustrative embodiment, the core member is formed of a relatively light weight thermoplastic material, examples of which may include, but should not be limited to, polypropylene, high density polyethylene or the like, although other materials or material combination for the core member are contemplated. The outer and inner skins 29, 28 respectively are each bonded to the opposite surface of the core member 26 using conventional adhesive or other conventional bonding medium.

In the specific embodiment, the joint 50 between abutting sides (i.e., front and rear edges 38) of right and left roof panels 30 is shown in FIG. 5. A portion of the outer skin 29 of the right roof panel 30 extends beyond and along the side of the right roof panel 30 that is defined by terminal edges of the core member 26 and the inner skin 28 of the right roof panel 30, as a skin extension 52. A skin extension 54 of the inner skin 28 of the left roof panel 30 extends beyond and along the side of the left roof panel 30 that is defined by a terminal edge of the core member 26 and the outer skin 29 of the left roof panel 30. Illustratively, a portion of the core member 26 of the left roof panel 30 to which the outer skin extension 52 of the right roof panel 30 is bonded is reduced to define a region of reduced thickness 56 of the left roof panel 30. Similarly, a portion of the core member 26 of the right roof panel 30 to which the inner skin extension 54 of the left roof panel 30 is bonded is reduced to define a region of reduced thickness 58 of the right roof panel 30.

A bonding medium 60 is disposed between the outer skin extension 52 of the right roof panel 30 and the region of reduced thickness 56 of the left roof panel 30. A bonding medium 60 is also disposed between the inner skin extension 54 of the left roof panel 30 and the region of reduced thickness 58 of the right roof panel 30 in order to couple the right and left roof panels 30 together. In one embodiment, the bonding medium may be a formable bonding medium that cures to a hardened state. In one specific embodiment, the formable medium may be or may include a conventional adhesive. For example, the formable medium may be provided in the form of a two-part epoxy or acrylic adhesive that cures to a hardened state after mixing the two parts together in a conventional manner. Alternatively, the formable bonding medium may be or include a conventional sealing medium or other conventional bonding medium. In an alternative embodiment, the bonding medium may be provided in the form of strips of a double sided adhesive tape wherein one or more strips are positioned between the outer skin extension 52 and the region of reduced thickness 56, and one or more other strips are positioned between the inner skin extension 54 and the region of reduced thickness 58. Such an illustrative shiplap panel joining structure is disclosed in U.S. Pat. No. 8,025,331 titled ROOF ASSEMBLY FOR A STORAGE CONTAINER and assigned to Wabash National, L.P., the entirety of the disclosure of which is hereby incorporated by reference herein.

Alternative panel joining structures and/or techniques may be used to join together the roof panels 30 and examples of some such alternative panel jointing structures and/or techniques are set forth in U.S. Pat. No. 4,940,279, the entirety of the disclosure of which is incorporated herein by reference. It will be understood, however, that joining the various roof panels should not be limited to the shiplap joining technique just described and/or the structures and techniques illustrated in the '279 patent, and that this disclosure further contemplates using other conventional structures and/or techniques for joining together the various roof panels. For example, conventional attachment structures, e.g., logistics rails or strips, may be used to attach abutting edges of the roof panels together. Other examples will occur to those skilled in the art, and such other examples are contemplated by this disclosure.

One or more of the roof panels 30 may illustratively include one or more embossments (not shown). For example, the top surface 32 of at least one of the roof panels 30 may include elongated embossments extending generally laterally across a width of the storage container 14. Alternatively, the one or more panels may include any number of embossments that extend along the top surface of one or more of the roof panels along any desired orientation or with random orientation. Alternatively still, the top surface 32 and/or the bottom surface 34 of one or more of the roof panels 30 may include one or more embossments. In addition to or in lieu of the embossments, one or more of the roof panels 30 may illustratively include one or more corrugations (not shown) as well. Any such embossments and/or corrugations may illustratively be provided for the purpose of imparting strength, stiffness or rigidity to the one or more roof panels. Any such embossments and/or corrugations may alternatively or additionally impart other properties to the one or more roof panels. The one or more embossments and/or corrugations may be formed of, for example, metal or metal composite, thermoplastic or other plastic material, or other material(s).

Illustratively, as noted above, the roof panels 30 are coupled directly to the sidewall panels 18 of each sidewall 16 of the storage container 14 such that the illustrative storage container 14 does not include any top rails typically provided in order to couple sidewalls of a typical storage container to the roof assembly of such a storage container. Specifically, the flanges 40 of each roof panel 30 are coupled directly to the sidewalls 16 of the storage container 14. Accordingly, the storage container 14, and particularly the sidewalls 16 of the storage container 14, does not include any top rails configured to extend along a length of the trailer 12. Rather, the need for top rails is obviated by the flanges 40 of the one-piece roof panels 30 which are configured to be coupled directly to the sidewall panels 18 of the storage container 14.

Further, as noted above, the flanges 40 of each roof panel 30 are configured to extend downwardly from the main body 31 of each roof panel 30 at approximately a 90 degree angle. As such, the flanges 40 are configured to define a generally vertical plane parallel to a plane defined by the sidewall panels 18 of each sidewall 16. Illustratively, as shown in FIG. 5, generally no portion of the roof assembly 10, or of each roof panel 30, extends into the interior of the storage container 14 inside the vertical plane defined by the sidewall panels 18. Thus, no portion of the roof assembly 10 or of the sidewall 16 extends inwardly into the cargo area of the storage container 14 beyond the inner surface of the sidewall panels 18, thus maximizing the usable interior width of the storage container 14.

As noted above, the storage container 14 is void of any top rails extending along a length of the container 14 and typically used to couple the sidewall panels of a storage container 14 to the roof assembly. Additionally, the illustrative storage container 14 also does not include any internal beams coupled to the roof assembly 10 which extend laterally across a width of the roof assembly 10. Such beams are not necessary due to the increased strength of the roof assembly 10 provided by the composite panels 18. Illustratively, while the storage container 14 does not include any laterally-extending support beams, commonly referred to as roof bows, coupled to the roof assembly 10, it should be understood that such laterally-extending roof support beams may be provided as well.

Illustratively, the lack of roof bows may operate to provide increased storage within the cargo area (not shown) of the storage container 14. Further, the lack of top rails may also operate to provide increased storage within the cargo area of the storage container 14. Illustratively, the roof bows generally extend downwardly from an inner surface (such as the inner surface 34 of the roof assembly 10) of the roof panels of a roof assembly and into the storage area of the container 14. Further, top rails may intrude laterally into the cargo area of the container 14 in that at least a portion of such top rails may extend inwardly beyond the generally vertical plane of the sidewall panels of the sidewall.

The top rails and roof bows may reduce the usable height and/or width of the storage container 14, thus reducing the amount of cargo which may be carried within the storage container 14. Further, intruding portions of the top rails and roof bows may be damaged from fork truck masts and cargo as the cargo is loaded and unloaded into and out of the storage container 14. Illustratively, the roof assembly 10, provided without roof bows and without top rails, therefore, reduces the potential for damage from fork truck masts and/or cargo by providing an increased inside height and width and a snag-free, smooth interior ceiling surface 34. Accordingly, the generally smooth interior surface 34 of the roof assembly 10, which does not include any roof bows or transverse stiffeners attached thereto, removes any protrusions into the cargo space of the storage container 14 which might otherwise be hit or bumped by freight during a loading or unloading process, for example. As such, persons, freight, or vehicles, such as forklifts, which are used to carry freight into and out of the trailer 12 do not accidently bump any such top rails or roof bows thus preventing any damage caused thereto. Furthermore, the elimination of the roof bows and top rails may operate to increase the amount of cargo which may be carried within the storage container 14. Additionally, the elimination of the top rails and roof bows may further operate to decrease the overall tare weight of the trailer 12. Such elimination of the top rails and roof bows may also operate to reduce the overall component count of the trailer 12. As such, the reduction in tare weight and component count may result in cheaper material cost and lower assembly labor required to build the illustrative trailer 12, thus resulting in a lower cost to the consumer due to both fewer parts and less labor required to assemble such parts.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A roof assembly of a storage container having two opposing sidewalls, including one or more sidewall panels, that together define a length of the trailer, comprising:
a plurality of roof panels arranged atop and between the two opposing sidewalls along the length of the storage container in side-by-side relationship, wherein each roof panel includes
(i) a main body;
(ii) a first flange extending downwardly from a first lateral edge of the main body to define a first approximately 90° bend, the first flange being configured to be coupled to and engaged with one of the sidewall panels of the trailer; and
(iii) a second flange extending downwardly from a second lateral edge of the main body to define a second approximately 90° bend, the second flange being configured to be coupled to and engaged with one other of the sidewall panels of the trailer.

2. The roof assembly of claim 1, wherein the first flange, the second flange, and the main body define a one-piece structure.

3. The roof assembly of claim 1, wherein each roof panel includes opposite sides and opposite ends, and wherein adjacent roof panels are coupled to each other in such a way as to form a shiplap joint between opposite sides of the adjacent roof panels.

4. The roof assembly of claim 1, further comprising an adhesive between opposite sides of adjacent roof panels in order to couple adjacent roof panels to each other.

5. The roof assembly of claim 1, further comprising adhesive on an inside surface of each flange of each one of the plurality of roof panels such that each flange is configured to be coupled directly to a top portion of one of the sidewall panels of the trailer.

6. The roof assembly of claim 1, wherein each roof panel is made from a composite material.

7. The roof assembly of claim 6, wherein the composite material includes an outer metal skin, an inner metal skin, and a foam core between the inner and outer metal skins.

8. The roof assembly of claim 1, wherein each of the plurality of roof panels is formed by roll-forming top and bottom end portions of a planar sheet of material to form a one-piece structure.

9. The roof assembly of claim 1, wherein the main body of each roof panel is generally planar.

10. The roof assembly of claim 1, wherein the main body of each roof panel is bowed between first and second lateral edges thereof such that the roof assembly is substantially dome-shaped along a longitudinal axis defined by the trailer centrally between the two opposing side walls of the trailer.

11. The roof assembly of claim 1, wherein the roof assembly is void of support structure extending laterally between the sidewalls of the trailer and coupled to the main body, the first flange, and the second flange of the roof panel.

12. A roof assembly of a trailer, comprising:
a one-piece roof panel including
(i) a main body configured to extend a width of the trailer between a first and a second sidewall of the trailer;
(ii) a first bend at a first lateral edge of the main body;
(iii) a first flange extending downwardly from the first bend;
(iv) a second bend at a second lateral edge of the main body; and
(v) a second flange extending downwardly from the second bend.

13. The roof assembly of claim 12, wherein the one-piece roof panel includes an outer skin, an inner skin, and a foam core between the inner and outer skins.

14. The roof assembly of claim 13, further comprising a plurality of one-piece roof panels such that abutting first and second lateral edges of adjacent ones of the plurality of roof panels are configured to be attached together by overlapping the outer skin along the adjacent side of one of the adjacent roof panels onto the other adjacent roof panel and overlapping the inner skin along the adjacent side of the other adjacent roof panel onto the one of the adjacent roof panels.

15. The roof assembly of claim 13, wherein the inner and outer skins are metal.

16. The roof assembly of claim 12, further comprising an adhesive coupled to (i) an inner surface of the first flange and (ii) an inner surface of the second flange such that the inner surface of the first flange is configured to be coupled to and engaged with an outer surface of a sidewall panel of the first sidewall of the trailer and the inner surface of the second flange is configured to be coupled to and engaged with an outer surface of a sidewall panel of the second sidewall of the trailer.

17. A trailer comprising:
a floor assembly;
a first sidewall coupled to a first side of the floor assembly and extending upwardly therefrom, wherein the first sidewall includes a first plurality of sidewall panels coupled to each other and extending the length of the trailer;
a second sidewall coupled to a second side of the floor assembly and extending upwardly therefrom, wherein the second sidewall includes a second plurality of sidewall panels coupled to each other and extending the length of the trailer; and
a roof assembly coupled directly to the first plurality of sidewall panels and coupled directly to the second plurality of sidewall panels, wherein the roof assembly includes a plurality of roof panels arranged atop and between the first and second sidewalls along the length of the trailer in side-by-side relationship, wherein each roof panel includes
(i) a main body,
(ii) a first flange extending downwardly from a first lateral edge of the main body, and
(iii) a second flange extending downwardly from a second lateral edge of the main body,
wherein the first flange is coupled to an outer surface of the first sidewall and the second flange is coupled to an outer surface of the second sidewall, and
wherein each roof panel defines a one-piece structure made from a composite material including an outer skin, an inner skin, and a foam core between the inner and outer skins.

18. The trailer of claim 17, wherein each sidewall panel of the first and second plurality of sidewall panels is made from a composite material and includes an outer skin, an inner skin, and a foam core between the inner and outer skins, and further wherein the inner skin of the first flange of each roof panel is engaged with and adhesively coupled to the outer skin of the first plurality of sidewall panels, and the inner skin of the second flange of each roof panel is engaged with and adhesively coupled to the outer skin of the second plurality of sidewall panels.

19. The trailer of claim 17, wherein no portion of the roof assembly extends inwardly into the trailer beyond an inner surface of each of the first and second plurality of sidewall panels.

20. The trailer of claim 17, wherein the first flange is generally parallel to the first plurality of sidewall panels and the second flange is generally parallel to the second plurality of sidewall panels.
